(19) United States
(12) Patent Application Publication
(10) Pub. No.: US 2016/0334896 A1
(43) Pub. Date: Nov. 17, 2016

(54) MULTILAYER STRUCTURE AND TOUCH PANEL MODULE

(71) Applicant: FUJIFILM Corporation, Tokyo (JP)

(72) Inventors: Takashi KOIKE, Kanagawa (JP); Hiroyuki KOBAYASHI, Kanagawa (JP); Tetsuji NISHIDA, Kanagawa (JP); Hisashi TSUBATA, Kanagawa (JP)

(73) Assignee: FUJIFILM Corporation, Tokyo (JP)

(21) Appl. No.: 15/218,518

(22) Filed: Jul. 25, 2016

Related U.S. Application Data
(63) Continuation of application No. PCT/JP2015/052059, filed on Jan. 26, 2015.

(30) Foreign Application Priority Data
Feb. 19, 2014 (JP) 2014-029818

(51) Int. Cl. G06F 3/041; B32B 27/36; B32B 7/02; B32B 7/12; B32B 27/08

(52) U.S. Cl. CPC G06F 3/041; B32B 7/12; B32B 27/08; B32B 7/02; B32B 27/36; B32B 2255/10; B32B 2255/205; B32B 2307/202; B32B 2307/412; B32B 2457/208; G06F 2203/04102; G06F 2203/04112

(57) ABSTRACT

A multilayer structure has a laminate including a transparent conductive member having a conductive pattern having a mesh structure composed of thin metal wires on a transparent substrate having flexibility, a protective member for protecting the transparent conductive member, and an optically transparent adhesive layer disposed between the transparent conductive member and the protective member. The thickness of the laminate is 100 μm or more and 600 μm or less. The thickness of the adhesive layer is 20% or more of the thickness of the laminate. The thermal shrinkage of the transparent conductive member at 150° C. is 0.5% or less, and a difference between the thermal shrinkage of the transparent conductive member and the thermal shrinkage of the protective member at 150° C. is within 60% of the thermal shrinkage of the transparent conductive member at 150° C. The multilayer structure is used for a touch panel module having a three-dimensional shape.

### CROSS-REFERENCE TO RELATED APPLICATIONS

This application is a Continuation of PCT International Application No. PCT/JP2015/052059 filed on Jan. 26, 2015, which claims priority under 35 U.S.C. §119(a) to Japanese Patent Application No. 2014-029818 filed on Feb. 19, 2014. The above application is hereby expressly incorporated by reference, in its entirety, into the present application.

### BACKGROUND OF THE INVENTION

1. Field of the Invention

The present invention relates to a multilayer structure used for a touch panel having a three-dimensional shape and a touch panel module, and particularly relates to a multilayer structure that can be processed into a desired three-dimensional shape without lifting and peeling being caused and a touch panel module.

2. Description of the Related Art

In recent years, employing a touch panel as an input device for portable electronic devices such as a smartphone or a tablet PC has been increased. It is required for these devices to have high portability, operability, and designability. For example, a touch panel having sensitivity on the side surface is required.

JP2013-182548A discloses a touch panel device in which a user can perform a touch operation in which the user touches a touch surface or a side peripheral surface with a finger or the like and a hover operation in which the user operates the device with a finger or the like in a state of being slightly lifted above the surface. A liquid crystal display device is provided below the touch surface and a user can perform a touch operation or a hover operation according to the displayed image of the liquid crystal display device. Incidentally, in JP2013-182548A, a surface touch mode for performing a surface touch operation and a side surface touch mode for performing a side surface touch operation are selectively used.

In the case of producing a touch panel having sensitivity on the side surface in addition to the surface as disclosed in JP2013-182548A, it is required to mold the touch panel into a three-dimensional shape. For example, JP2013-12604A discloses a method capable of molding a conductive base film at least provided with a conductive layer including a metal silver portion prepared by a silver-salt method into a three-dimensional shape (a shape having concavities and convexities, or a curved surface) without fracturing of the metal silver portion. The conductive film having a three-dimensional shape can be obtained by molding a flat conductive base film into a curved shape, a rectangular parallelepiped shape, a button shape, a columnar shape, a combination of these shapes, or the like under the condition of a predetermined load.

### SUMMARY OF THE INVENTION

However, in the touch panel having sensitivity on the side surface as disclosed in JP2013-182548A, there arise problems in that the surface touch mode and the side surface touch mode have to be selectively used and a touch panel having sufficient sensitivity on the side surface is required to be provided since the sensitivity of the side surface is not sufficient. In this case, it is required to dispose an electrode for detecting a finger or the like on the side surface. However, ITO is composed of a metal oxide and cracking occurs due to processing. Thus, it is not possible to dispose an electrode on the side surface in the case of using ITO. In addition, the use of ITO costs a lot and thus it is not possible to form an electrode at a low cost.

Although a conductive base film that can be molded into a three-dimensional shape is disclosed in JP2013-12604A, when the conductive base film is actually molded into a three-dimensional shape for a touch panel, there arises a problem of the occurrence of lifting or peeling. This lifting and peeling become fatal defects which cause significant side effects for visibility of a touch panel.

Currently, when a touch panel shaped into a three-dimensional shape is produced, a touch sensor film that can be processed into a desired three-dimensional shape without lifting and peeling being caused has been required.

An object of the present invention is to solve the problems based on the aforementioned related art and to provide a multilayer structure that can be processed into a desired three-dimensional shape without lifting and peeling being caused and a touch panel module using, the multilayer structure.

In order to achieve the above object, the present invention provides a multilayer structure comprising a laminate comprising a transparent conductive member having a conductive pattern having a mesh structure composed of thin metal wires on a transparent substrate having flexibility, a protective member for protecting the transparent conductive member, and an optically transparent adhesive layer disposed between the transparent conductive member and the protective member, wherein the thickness of the laminate is 100 μm or more and 600 μm or less, the thickness of the adhesive layer is 20% or more of the thickness of the laminate, the thermal shrinkage of the transparent conductive member at 150° C. is 0.5% or less, and a difference between the thermal shrinkage of the transparent conductive member and the thermal shrinkage of the protective member at 150° C. is within 60% of the thermal shrinkage of the transparent conductive member at 150° C.

For example, the protective member is disposed on the side of the transparent conductive member in which the thin metal wires are provided.

The conductive pattern formed on the transparent substrate may be formed on both surfaces or may be formed on only one surface of the substrate.

Further, in the case in which the conductive pattern is formed on only one surface of the transparent substrate, the protective member can be also provided on the side opposite to the side of the transparent conductive member in which the thin metal wires are provided and the adhesive layer can be disposed between the transparent conductive member and the protective member on the opposite side. The laminate may have a three-dimensional shape.

In addition, there is provided a touch panel module comprising the multilayer structure of the present invention.

According to the multilayer structure of the present invention, it is possible to process a multilayer structure into a desired three-dimensional shape without lifting and peeling being caused even when the multilayer structure is heated during the molding of the multilayer structure into a three-dimensional shape. Further, it is also possible to provide a touch panel module having a three-dimensional shape using the multilayer structure.

### BRIEF DESCRIPTION OF THE DRAWINGS

FIG. 1A is a schematic view showing a multilayer structure according to an embodiment of the present invention, and FIG. 1B is a schematic cross-sectional view showing an example of a transparent conductive member.

FIG. 2A is a schematic view showing another example of the multilayer structure according to the embodiment of the present invention, and FIG. 2B is a schematic cross-sectional view showing an example of a transparent conductive member.

FIG. 3A is a schematic view showing an electrode pattern of a first detection electrode, and FIG. 3B is a schematic view showing an electrode pattern of a second detection electrode.

FIG. 4 is a schematic view showing an electrode configuration of the transparent conductive member of the multilayer structure according to the embodiment of the present invention.

FIGS. 5A to 5C are schematic views showing a method of molding the multilayer structure according to the embodiment of the present invention.

FIG. 6A is a schematic perspective view showing a touch panel having a touch panel module according to the embodiment of the present invention, FIG. 6B is a schematic cross-sectional view showing a main part of the touch panel module in FIG. 6A, and FIG. 6C is a schematic cross-sectional view showing another example of the main part of the touch panel module in FIG. 6A.

### DESCRIPTION OF THE PREFERRED EMBODIMENTS

Hereinafter, a multilayer structure and a touch panel module of e present invention will be described in detail based on preferable embodiments shown in the accompanying drawings.

As a result of intensive investigations conducted by the present inventors, the present invention has been found that as a result of investigating a mechanism of lifting or peeling occurring when a laminate including a transparent conductive member having a conductive pattern composed of thin metal wires, a protective member for protecting, the surface of the transparent conductive member, and an optically transparent adhesive layer disposed between the transparent conductive member and the protective member is deformed into a three-dimensional shape, lifting or peeling occurs due to the behavior of returning the state of the transparent conductive member, the protective member, or the like in the shaped laminated to the state before the shaping. Further, it has been found that the phenomenon that lifting or peeing occurs can be eliminated by defining the thickness of the laminate and the thickness of the adhesive layer in the laminate, and further a relationship between the thermal shrinkage of the transparent conductive member and the thermal shrinkage of the protective member.

Here, in the present invention, the thickness of the laminate is set to 100 μm to 600 μm, the thickness of the adhesive layer is set to be 20% or more of the thickness of the laminate, the thermal shrinkage of the transparent conductive member at 150° C. is set to 0.5% or less, and a difference between the thermal shrinkage of the transparent conductive member and the thermal shrinkage of the protective member is set to be within 60% of the thermal shrinkage of the transparent conductive member. It is found that by employing this configuration, the laminate can be processed into a desired three-dimensional shape without causing lifting or peeling even when the laminate is heated during the shaping of the laminate into a three-dimensional shape and the present invention has been completed.

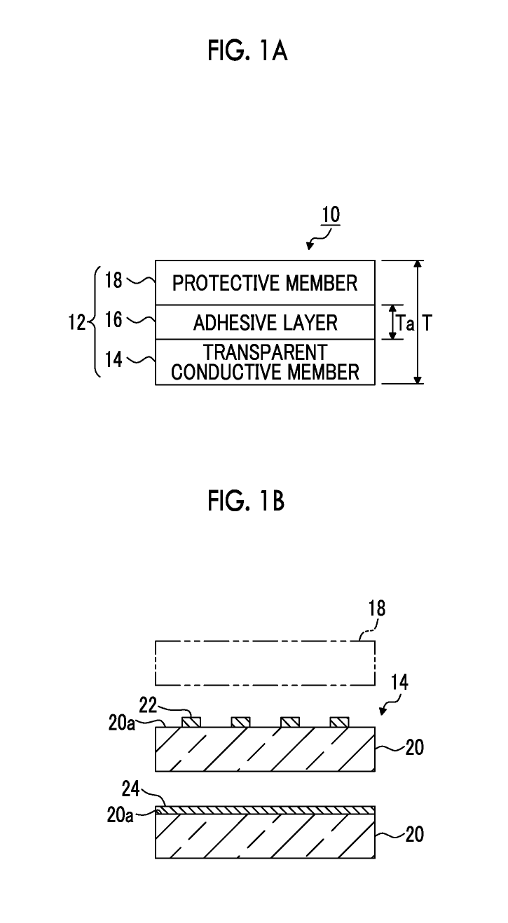

Hereinafter, the multilayer structure and the touch panel module will be specifically described. FIG. 1A is a schematic view showing a multilayer structure according to an embodiment of the present invention, and FIG. 1B is a schematic cross-sectional view showing an example of a transparent conductive member. In FIG. 1B, an adhesive layer 16 is not shown.

A multilayer structure 10 shown in FIG. 1A is used for a touch panel and is molded into a three-dimensional shape. The multilayer structure 10 is composed of a laminate 12 having a transparent conductive member 14, and adhesive layer 16, and a protective member 18. In the laminate 12, the protective member 18 is attached to the transparent conductive member 14 with the adhesive layer 16.

In the multilayer structure 10, the thickness T of the laminate 12 is 100 μm or more and 600 μm or less. In the case in which the thickness T of the laminate 12 is less than 100 μm and in the case in which heat treatment is performed during the molding processing of the laminate into a three-dimensional shape, when the heat treatment is performed, the shape of the laminate 12 cannot be maintained. On the other hand, in the case in which the thickness T of the laminate 12 is more than 600 μm, during the molding processing of the laminate into a three-dimensional shape, the force of returning the state of the laminate to the state before shaping increases and the laminate 12 is not easily molded. Here, the force of returning the state of the laminate to the state before shaping refers to, for example, a force of, in the case of bending both flat end portions, retuning the state of the bent portions to a flat shape.

The thickness T of the laminate 12 is preferably 100 μm or more and 400 μm or less and more preferably 100 μm or more and 250 μm or less.

The transparent conductive member 14 corresponds to a touch sensor portion of a touch panel. This transparent conductive member 14 has a conductive pattern having a mesh structure composed of thin metal wires formed on a transparent substrate 20 (refer to FIG. 1B) having flexibility.

In the transparent conductive member 14, as shown in FIG. 1B, a first detection electrode 22 composed of thin metal wires is formed on a front surface 20a of the transparent substrate 20 having flexibility and a second detection electrode 24 composed of thin metal wires is formed on a front surface 20a of another transparent substrate 20. The transparent substrate 20 in which the first detection electrode 22 is formed on one surface, and another transparent substrate 20 in which the second detection electrode 24 is formed on one surface are laminated to constitute the transparent conductive member 14. In the transparent conductive member 14, the first detection electrode 22 and the second detection electrode 24 are disposed to be opposite to each other so as to be orthogonal to each other in a plan view. The first detection electrode 22 and the second detection electrode 24 are provided for detecting a touch. The patterns of the first detection electrode 22 and the second detection electrode 24 will be described in detail later.

One transparent conductive member 14 in which the first detection electrode 22 is formed on the front surface 20a of the transparent substrate 20 may be provided.

Here, the term “transparent” refers to a light transmittance of at least 60% or more at a visible ray wavelength (wavelength of 400 nm to 800 nm), preferably 80% or more, more preferably 90% or more, and still more preferably 95% or more.

The protective member 18 is provided for protecting the transparent conductive member 14, particularly the detection electrode. The configuration of the protective member 18 is not particularly limited as long as the transparent conductive member 14, particularly the detection electrode, can be protected. For example, glass, polycarbonate (PC), polyethylene terephthalate (PET), and the like can be used. The protective member can also function as touch surface. At least one of a hard coat layer or an antireflection layer can be provided on the surface of the protective member.

The adhesive layer 16 is provided for attaching the protective member 18 to the transparent conductive member 14 and is composed of an optically transparent layer. The adhesive layer 16 is not particularly limited as long as the layer is optically transparent and is capable of attaching the protective member 18 to the transparent conductive member 14. For example, an optically clear adhesive (OCA) and an optically clear resin (OCR) such as an UV curable resin, or the like can be used. Here, the term “optically transparent” is the same as the above definition of the term “transparent”.

The shape of the adhesive layer 16 is not particularly limited and may be formed by applying an adhesive or using an adhesive sheet.

The thickness of the adhesive layer 16 is 20% or more of the thickness T of the laminate 12. That is, when the thickness of the adhesive layer 16 is Ta, the thickness Ta of the adhesive layer 16 is Ta≧0.2 T.

When the thickness Ta of the adhesive layer 16 is less than 20% or the thickness T of the laminate 12, during the molding of the multilayer structure 10 into a three-dimensional shape, the force of returning the shape of the transparent conductive member 14 and the protective member 18 to the shape before shaping cannot be completely absorbed and peeling occurs at any of the interfaces of the laminate 12. Here, in the case of the occurrence of peeling, the member is partially separated and lifted at the lamination interface and as a result, the member is peeled off from the lamination interface. Thus, both lifting and peeling are included in the term “peeling”. Therefore, the term “peeling” includes both lifting and peeling in the following description.

The thickness Ta of the adhesive layer 16 to the thickness T of the laminate 12 is preferably Ta 0.23 T and more preferably Ta ≧25 T. As the thickness of the adhesive layer 16 increases, the adhesive strength becomes more rigid and becomes stronger against lifting and peeling. The upper limit of the thickness Ta of the adhesive layer 16 is not particularly limited and the upper limit is set to be appropriate according to material costs or a design constraint of a touch panel module or the like.

In the laminate 12, the thermal shrinkage of the transparent conductive member 14 at 150° C. is 0.5% or less. The difference between the thermal shrinkage of the transparent conductive member 14 and the thermal shrinkage of the protective member 18 is set to be within 60% of the thermal shrinkage of the transparent conductive member 14 at 150° C. The difference between the thermal shrinkage of the transparent conductive member 14 and the thermal shrinkage of the protective member 18 is preferably within 50% of the thermal shrinkage of the transparent conductive member 14 at 150° C. and more preferably within 40% of the thermal shrinkage of the transparent conductive member.

When the thermal shrinkage of the transparent conductive member 14 at 150° C. is more than 0.5%, in the case of performing heat treatment during the molding of the laminate into a three-dimensional shape, the transparent conductive member 14 is peeled off. The thermal shrinkage of the transparent conductive member 14 at 150° C. is preferably 0.2% or less.

When the difference between the thermal shrinkage of transparent conductive member 14 and the thermal shrinkage of the protective member 18 is more than 60% of the thermal shrinkage of the transparent conductive member 14 at 150° C., the behavior of thermal contraction of one of the members increases excessively and thus peeling occurs at any of the interfaces of the laminate 12.

Since the absolute value of the difference between the thermal shrinkage of the transparent conductive member 14 and the thermal shrinkage of the protective member 18 has to be within 60% of the thermal shrinkage of the transparent conductive member 14 at 150° C. ((thermal shrinkage of transparent conductive member—thermal shrinkage of protective member)/thermal shrinkage of transparent conductive member), a combinations of materials satisfying the above thermal shrinkage relationship is suitably used.

Incidentally, the thermal shrinkage in the present invention is obtained by measuring a change in dimension before and after each member is left to stand for 30 minutes under the environment of a temperature of 150° C. Specifically, in each of the transparent conductive member 14 and the protective member 18, two preset points are set and a distance between these two points is measured. Thereafter, each of the transparent conductive member 14 and the protective member 18 is left to stand for 30 minutes under the environment of a temperature of 150° C. and then a distance between two reset points is measured. The thermal shrinkage can be measured by obtaining a change in the distance between the two points before and after each material is left to stand for 30 minutes under the environment of a temperature of 150° C.

Regarding the thermal shrinkage of the members constituting the multilayer structure 10, from the viewpoint of preventing unintended deformation of the members due to the heat treatment during the molding of the multilayer structure into a three-dimensional shape, it is preferable that thermal contraction does not occur. However, it is difficult to find such a member in reality and it is also difficult to obtain other satisfactory properties such as optical properties and the like and prevent thermal contraction.

The transparent substrate 20 has flexibility and supports the first detection electrode 22 and the second detection electrode 24. The transparent substrate 20 can be formed by using, for example, a plastic film, a plastic plate, a glass plate and the like. For example, the plastic film and the plastic plate can be composed of polyesters such as polyethylene terephthalate (PET) and polyethylene naphthalate (PEN), polyolefins such as polyethylene (PE), polypropylene (PP), polystyrene, ethylene vinyl acetate (EVA), cycloolefin polymers (COP), and cycloolefin copolymers (COC), vinyl-based resins, as well as polycarbonate (PC), polyamide, polyimide, acrylic resin, triacetyl cellulose (TAC), and the like. From the viewpoint of light transmittance, thermal shrinkage properties, workability, and the like, it is preferable that the transparent substrate is composed of polyethylene terephthalate (PET).

For example, the first detection electrode 22 and the second detection electrode 24 are composed of a mesh electrode having a conductive mesh pattern as described later in detail. The first detection electrode 22 and the second detection electrode 24 are composed of thin metal wires having conductivity. This thin metal wire is not particularly limited and is formed of for example, ITO, Au, Ag or Cu. The thin metal wire constituting the first detection electrode 22 and the second detection electrode 24 may further include a binder in addition to ITO, Au, Ag or Cu. When the thin metal wire includes a binder, bending processing is easily performed and bending resistance is improved. Therefore, it is preferable that the first detection electrode 22 and the second detection electrode 24 are composed of a conductor including a binder. As the binder, binders which are used for wiring of conductive films can be appropriately used. For example, binders disclosed in JP2013-149236A can be used.

Since the first detection electrode 22 and the second detection electrode 24 are composed of a mesh electrode formed by crossing thin metal wires to form a mesh shape, the resistance can be lowered and disconnection does not easily occur when the multilayer structure is molded into a three-dimensional shape. Further, even in the case of the occurrence of disconnection, the influence on the resistance value of the detection electrodes can be reduced.

It is required that the width of the thin metal wire of the first detection electrode 22 and the second detection electrode 24 is as narrow as possible from the viewpoint of visibility or the like. From this viewpoint, the width of the first detection electrode 22 and the second detection electrode 24 is preferably less than 7 μm and more preferably 5 μm or less.

The method of forming the first detection electrode 22 and the second detection electrode 24 is not particularly limited. For example, the electrodes can be formed by exposing a photosensitive material having an emulsion layer containing a photosensitive silver halide and subjecting the photosensitive material to developing treatment. In addition, the first detection electrode 22 and the second detection electrode 24 can be formed by forming a metal foils on the transparent substrate 20 and printing resists on each metal foil in a pattern shape or exposing an entirely applied resist, developing the resist to form a pattern, and etching a metal of an opening portion. In addition to the this method, examples of the method of forming the first detection electrode 22 and the second detection electrode 24 include a method of printing a paste including fine particles of the material constituting the aforementioned conductor and plating the paste with metal, and an ink jet method using an ink including fine particles of the material constituting the aforementioned conductor.

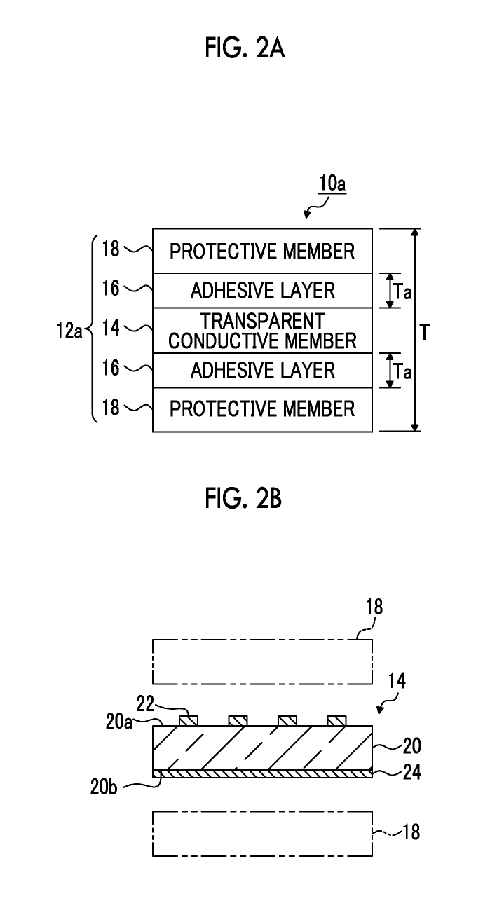

The present invention is not limited to the configuration of the multilayer structure 10. For example, the configuration of a multilayer structure 10a shown in FIG. 2A may be employed. The configuration of the multilayer structure 10a shown in FIG. 2A is different from the configuration of the multilayer structure 10 shown in FIG. 1A in that the protective member 18 is provided on both surfaces of the transparent conductive member 14 with the adhesive layer 16. Since other configurations are the same as the configurations of the multilayer structure 10 shown in FIG. 1A, the detailed description thereof will be omitted.

In the multilayer structure 10a, a laminate 12a is configured such that the layers are laminated in the order of the protective member 18, the adhesive layer 16, the transparent conductive member 14, the adhesive layer 16, and the protective member 18.

In the multilayer structure 10a, the thickness T of the laminate 12a is 100 μm or more and 600 μm or less. The reason for limiting the thickness T of the laminate 12a to the above numerical range is as described above.

In addition, two layers of adhesive layers 16 are provided in the laminate 12a. However, in this case, the relationship between the thickness Ta of the adhesive layers 16 and the thickness T of the laminate 12a is the total thickness of the two layers, that is, 2 Ta≧0.2 T.

The transparent conductive member 14 can employ a configuration in which the transparent substrate 20 having the first detection electrode 22 formed on only one surface and the transparent substrate 20 having the second detection electrode 24 formed on only one surface are laminated as shown in FIG. 1B. However, a configuration in which the first detection electrode 22 is formed on the front surface 20a of the transparent substrate 20 and the second detection electrode 24 is formed on the rear surface 20b as shown in FIG. 2B can be employed. That is, the first detection electrode 22 and the second detection electrode 24 may be formed on one transparent substrate 20. In FIG. 2B, the adhesive layer 16 is omitted.

Next, the first detection electrode 22 and the second detection electrode 24 will be specifically described.

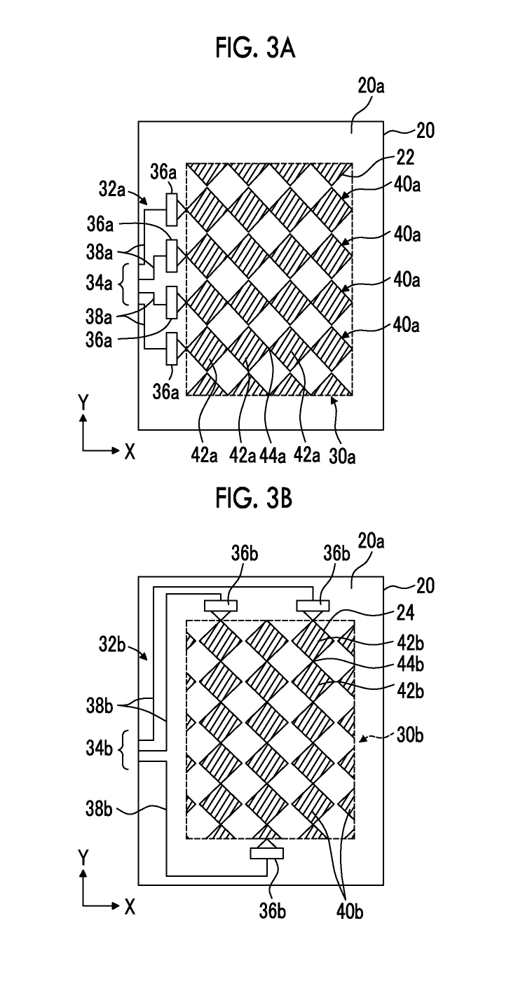

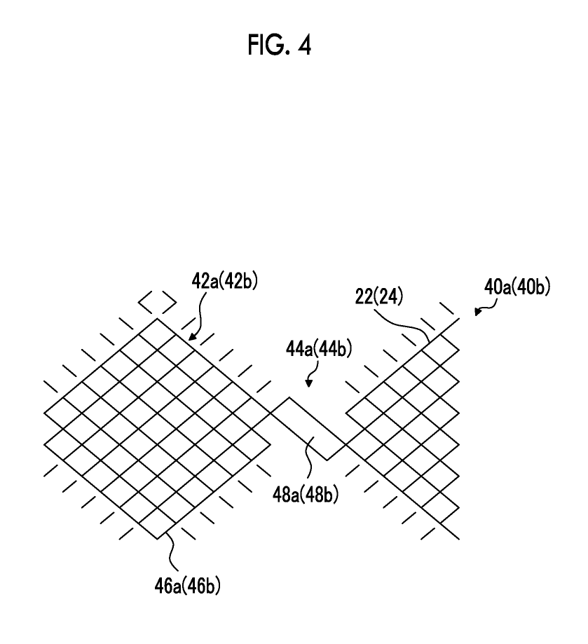

FIG. 3A is a schematic view showing an electrode pattern of the first detection electrode, and FIG. 3B is a schematic view showing an electrode pattern of the second detection electrode. FIG. 4 is a schematic view showing an electrode configuration of the transparent conductive member of the multilayer structure according to the embodiment of the present invention.

As shown in FIG. 3A, for example, the first detection electrode 22 is disposed in a first sensor portion 30a to be disposed in a display region of a display device. A first terminal wiring portion 32a which is connected to the first sensor portion 30a is provided in an outer peripheral region of the display region, that is, a frame.

The first sensor portion 30a has, for example, a rectangular shape. In the first terminal wiring portion 32a, at the middle portion of the peripheral edge portion of one side parallel with a second direction Y in the length direction, a plurality of first terminals 34a are arranged and formed in the second direction Y. Along one side of the first sensor portion 30a, that is, along a side parallel with the second direction Y, a plurality of first wire connection portions 36a are arranged nearly in a line. First terminal wiring patterns 38a led out from each of the first wire connection portions 36a are routed toward the first terminals 34a and are electrically connected to the corresponding first terminals 34a, respectively. For example, the first terminals 34a are connected to a detecting portion of a touch panel (not shown).

In the first sensor portion 30a, the first detection electrode 22 in the form of first conductive patterns 40a (mesh patterns) in which a plurality of thin metal wires cross to form a mesh shape is disposed. The first conductive patterns 40a respectively extend in a first direction X and are arranged in the second direction Y perpendicular to the first direction X. In addition, in each of the first conductive patterns 40a, two or more first large lattices 42a are connected in series in the first direction X. Between adjacent first large lattices 42a, a first connection portion 44a for electrically connecting these first large lattices 42a is formed.

On one end portion side of each of the first conductive patterns 40a, the first connection portions 44a are not formed at the open ends of the first large lattices 42a. On the other end portion side of each of the first conductive patterns 40a, at the end portions of the first large lattices 42a, the first wire connection portions 36a are respectively provided. Then, each of the first conductive patterns 40a is electrically connected to the first terminal wiring patterns 38a through each of the first wire connection portion 36a.

As shown in FIG. 3B, for example, the second detection electrode 24 is disposed in a second sensor portion 30b to be disposed on the display region of a display device. A second terminal wiring portion 32b which is connected to the second sensor portion 30b is provided in an outer peripheral region of the display region, that is, a frame.

The second sensor portion 30b is stacked and disposed on the first sensor portion 30a and has a rectangular shape. The first sensor portion 30a and the second sensor portion 30b are disposed to cross in a plan view.

In the second terminal wiring portion 32b, at the middle portion of the peripheral edge portion of one side parallel with the second direction Y in the length direction, a plurality of second terminals 34b are arranged and formed in the second direction Y. Along one side of the second sensor portion 30b, that is, along a side parallel with the first direction X, a plurality of second wire connection portions 36b, for example, odd-numbered second wire connection portions 36b are arranged nearly in a line. Along the other side of the second sensor portion 30b, that is, along a side opposite to one side, a plurality of second wire connection portions 36b, for example, even-numbered second wire connection portions 36b are arranged nearly in a line. Second terminal wiring patterns 38b led out from each of the second wire connection portions 36b are routed toward second terminals 34b and electrically connected to the corresponding second terminals 34b respectively.

In the second sensor portion 30b, the second detection electrode 24 in the form of second conductive patterns 40b (mesh patterns) in which a plurality of thin metal wires cross to form a mesh shape is disposed. The second conductive patterns 40b respectively extend in the second direction Y and are arranged in the first direction X perpendicular to the second direction Y. In addition, in each of the second conductive patterns 40b, two or more second large lattices 42b are connected in series in the second direction Y. Between adjacent second large lattices 42b, a second connection portion 44b for electrically connecting these second large lattices 42b is formed.

On one end portion side of each of the second conductive patterns 40b, the second connection portions 44b are not formed at the open ends of the second large lattices 42b. On the other end portion side of each of the second conductive patterns 40b, at the end portions of the second large lattices 42b, the second wire connection portions 36b are respectively provided. Then, each of the second conductive patterns 40b is electrically connected to the second terminal wiring patterns 38b through each of the second wire connection portion 36b.

As shown in FIG. 4, in the first conductive pattern 40a, each of the first large lattices 42a is configured by combining two or more first small lattices 46a, respectively. The shape of the first small lattice 46a is the smallest diamond herein and is the same as or similar to the aforementioned one mesh shape. The first connection portion 44a for connecting adjacent first large lattices 42a has an area equal or larger than the area of the first small lattice 46a and is composed of a first middle lattice 48a having an area smaller than the area of the first large lattice 42a.

Since the second conductive pattern 40b has the same configuration as the first conductive pattern 40a, the description thereof will be made using FIG. 4 in the same manner.

In the second conductive pattern 40b, each of the second large lattices 42b is configured by combining two or more second small lattices 46b , respectively. The shape of the second small lattice 46b is the smallest diamond shape and is the same as or similar to the aforementioned one mesh shape. The second connection portion 44b for connecting adjacent second large lattices 42b has an area equal to or larger than the area of the second small lattice 46b and is composed of a second middle lattice 48b having an area smaller than the second large lattice 42b.

Next, the method of molding g the multilayer structure of the embodiment will be described.

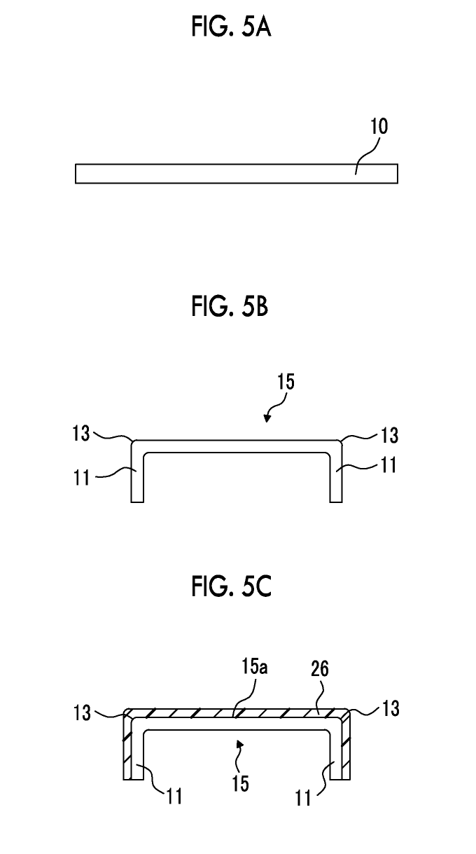

FIGS. 5A to 5C are schematic views showing the method of molding the multilayer structure according to the embodiment of the present invention.

As shown in FIG. 5A, first, the flat multilayer structure 10 is prepared. Then, the both end portions of the multilayer structure 10 are bent and the multilayer structure 10 is molded into a molded body 15 having a three-dimensional shape and having side surface portions 11 as shown in FIG. 5B. When the multilayer structure is molded into the molded body 15, the side surface portions 11 are formed by heating the flat multilayer structure 10 to a preset temperature and bending the both end portions and then the multilayer structure is cooled at room temperature. It is possible to prevent lifting and peeling from occurring in the laminate 12 by adjusting the thermal shrinkage and defining the thickness Ta of the adhesive layer 16 in the multilayer structure 10 as described above. Therefore, even when bending processing is performed, the multilayer structure can be processed into a preset specific three-dimensional shape without lifting and peeling being caused at a bent portion 13 or the like and thus a molded body 15 can be obtained.

Furthermore, for example, a resin layer 26 which covers a surface 15a of the molded body 15 is formed by performing insert molding on the molded body 15 shown in FIG. 5B. During the insert molding, the molded body 15 is placed in a mold and heated to a preset temperature, and then a resin is injected into the mold. Thus, a resin layer 26 is formed on the surface 15a of the molded body 15. Although heating is also performed in this case, the resin layer 26 can be formed without lifting and peeling being caused at the bent portion 13 or the like as in the molding of the aforementioned molded body 15.

Next, a touch panel module using the multilayer structure 10 will be described using a touch panel as an example.

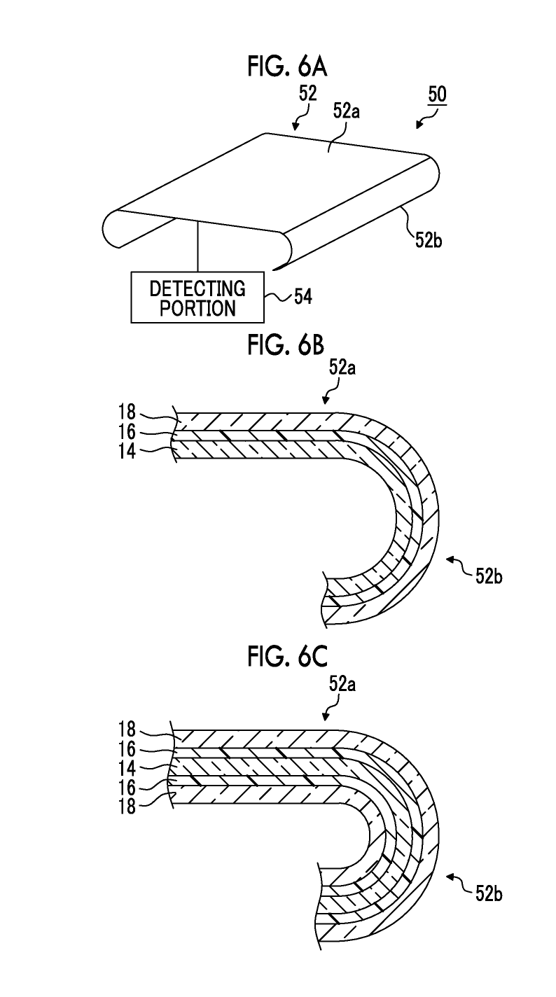

FIG. 6A is a schematic perspective view showing a touch panel having a touch panel module according to the embodiment of the present invention, FIG. 6B is a schematic cross-sectional view showing a main part of the touch panel module in FIG. 6A, and FIG. 6C is a schematic cross-sectional view showing another example of the main part of the touch panel module in FIG. 6A.

A touch panel 50 having a three-dimensional shape shown in FIG. 6A has a touch panel module 52 and a detecting portion 54. The touch panel module 52 is a detection sensor portion of the touch panel 50. The touch panel module 52 is composed of, for example, the aforementioned multilayer structure 10 or 10a and regarding the configuration of the electrode structure or the like, the description thereof will be omitted.

The touch panel module 52 is molded into a three-dimensional shape and has a display portion 52a in which a display device such as an LCD is provided, and side surface portions 52b which are bent such that both end portions of the display portion 52a become rounded. A touch to the touch panel module 52 is detected by the detecting portion 54.

The detecting portion 54 is composed of known detecting portions to be used for the detection of the touch panel. In the case of an electrostatic capacitance type, a detecting portion of an electrostatic capacitance type is used and in the case of a resistive film type, a detecting portion of a resistive film type is used appropriately.

In the case of using the multilayer structure 10 having the configuration shown in FIG. 1A, the side surface portions 52b of the touch panel module 52 become rounded as shown in FIG. 6B. However, the aforementioned lifting and peeling do not occur. In addition, in the case of using the multilayer structure 10a having the configuration shown in FIG. 2A, the side surface portions 52b are bent to become rounded as shown in FIG. 6C. However, the aforementioned lifting and peeling also do not occur in this case.

The present invention is basically configured as described above. The multilayer structure and the touch panel module of the present invention have been described above in detail. However, the present invention is not limited to the above embodiment and it is needless to say that various improvements or modifications may be made within a range not departing from the gist of the present invention.

### EXAMPLES

Hereinafter, the effect of the multilayer structure of the present invention will be described.

In the examples, Examples 1 to 5 and Comparative Examples 1 to 5 having configurations shown in Table 1 below were prepared and whether or not the member was peeled off was evaluated. For the adhesive layer, an OCA tape (product number: 8146) manufactured by 3M Corporation, was used. In Table 1 below, the term “one surface” in the column of a lamination structure type refers to the configuration of the multilayer structure 10 shown in FIG. 1A, term “both surfaces” refers to the configuration of the multilayer structure 10a shown in FIG. 2A.

In the examples, the states of Examples 1 to 5 and Comparative Examples 1 to 5 immediately after Examples and Comparative Examples were prepared was visually observed and whether or not the member was peeled off was confirmed. The results are shown in Table 1 below.

Further, an acceleration test was performed in Examples 1 to 5, and whether or not the member was peeled off after the acceleration test was visually confirmed. The results are shown in Table 1 below.

The acceleration test was performed by leaving the multilayer structures to stand in the environment of a temperature of 85° C. and a relative humidity of 85% for 24 hours. As the results of the acceleration test, “no practical problem” shown in Table 1 below refers to a level at which, due to a small area of the occurrence of peeling and peeling occurring only at the end portion of the member or the like, problems do not arise in a portion to be mainly used as a touch sensor and the degree of peeling is allowable as appearance defects.

In Comparative Examples 1 to 5, since the member was peeled off, the acceleration test was not performed. Therefore, the column of “peeling after acceleration test” in Table 1 below is marked with “-”.

In the examples, whether or not the member is peeled off is visually confirmed but due to an air layer present on the interface of the places where the member is peeled off, the refractive index or the light scattering state changes. Thus, the peeling can be easily visually confirmed.

In the examples, for the transparent conductive member, Preparation Examples 1 and 2 shown below were used. Hereinafter, Preparation Examples 1 and 2 will be described.

### Preparation Example 1

### Preparation of Conductive Base Film

[Preparation of Emulsion]

| | | |
|---|---|---|
| Solution 1: | | |
| Water | 750 | mL |
| Phthalated gelatin | 20 | g |
| Sodium chloride | 3 | g |
| 1,3-dimethylimidazolidine-2-thione | 20 | mg |
| Sodium benzenethiosulfonate | 10 | mg |
| Citric acid | 0.7 | g |
| Solution 2: | | |
| Water | 300 | mL |
| Silver nitrate | 150 | g |
| Solution 3: | | |
| Water | 300 | mL |
| Sodium chloride | 38 | g |
| Potassium bromide | 32 | g |
| Potassium hexachloroiridate(III) | 5 | mL |
| (0.005% in 20% aqueous KCl solution) | | |
| Ammonium hexachlororhodate | 7 | mL |
| (0.001% in 20% aqueous NaCl solution) | | |

The potassium hexachloroiridate (III) (0.005% in 20% aqueous KCl solution) and ammonium hexachlororhodate (0.001% in 20% aqueous NaCl solution) used in Solution 3 were prepared by dissolving complex powders thereof in a 20% aqueous solution of KCl and a 20% aqueous solution of NaCl, respectively, and heating the solutions at 40° C. for 120 minutes.

To Solution 1 which was held at 38° C. and pH 4.5, Solutions 2 and 3 (amounts corresponding to 90% of the respective solution amounts) were added simultaneously for 20 minutes with being stirred. In this manner, nucleus particles having a size of 0.16 μm were formed. Subsequently, Solutions 4 and 5 below were added thereto for 8 minutes, and the rests of Solutions 2 and 3 (amounts corresponding to 10% of the respective solution amounts) were further added thereto for 2 minutes so as to cause the particles to grow up to 0.21 μm in size. Furthermore, 0.15 g of potassium iodide was added thereto, and the resultant was aged for 5 minutes to end the formation of the particles.

| Solution 4: | | |
|---|---|---|
| Water | 100 | mL |
| Silver nitrate | 50 | g |
| Solution 5: | | |
| Water | 100 | mL |
| Sodium chloride | 13 | g |
| Potassium bromide | 11 | g |
| Potassium ferrocyanide | 5 | mg |

Thereafter, washing with water by the flocculation method according to the typical method was conducted. Specifically, the temperature was lowered to 35° C., and the pH was reduced using sulfuric acid until silver halide precipitated (precipitation occurred in the pH range of 3.6±0.2). Next, about 3 L of the supernatant was removed (first water washing). Further, 3 L of distilled water was added to the mixture, and sulfuric acid was added until silver halide precipitated. 3 L of the supernatant was removed again (second water washing). The procedure same as the second water washing was repeated once more (third water washing), and water-washing and desalting steps were thus completed. The pH and the pAg of the emulsion after washing and desalting were adjusted to 6.4 and 7.5, respectively. Thereto, 100 mg of 1,3,3a,7- tetraazaindene as a stabilizing agent, and 100 mg of PROXEL (trade name, manufactured by ICI Co., Ltd.) as an antiseptic were added. Finally, a silver iodochlorobromide cubic particle emulsion containing 70 mol % of silver chloride and 0.08 mol % of silver iodide and having an average particle diameter of 0.22 μm and a coefficient of variation of 9% was obtained. The emulsion had finally a pH of 6.4, a pAg of 7.5, an electrical conductivity of 4,000 μS/m, a density of 1.4×10³ kg/m³, and a viscosity of 20 mPa·s.

[Preparation of Emulsion Layer Coating Solution]

To the above emulsion, 8.0×10⁻⁴ mol/molAg of the following compound (Cpd-1) and 1.2×10^{×4} mol/molAg of 1,3,3a,7-tetraazaindene were added thereto and sufficiently mixed. Next, for the purpose of adjusting the swelling ratio, the following compound (Cpd-2) was added thereto and the pH of the coating solution was adjusted to 5.6 using citric acid.

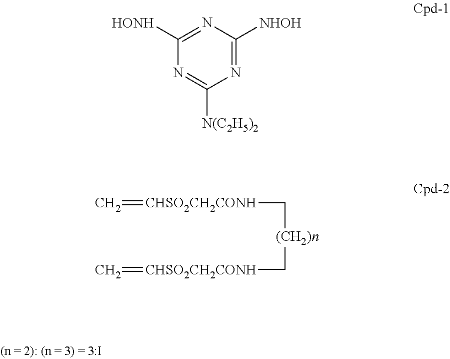

[Preparation of Transparent Base Film]

A PET film support having a thickness of 40 μm to 200 μm whose one surface or both surfaces had been subjected to corona discharge treatment and surface hydrophilization treatment was used.

[Preparation of Photosensitive Film]

The above emulsion layer coating solution was applied to the above PET film which had been subjected to corona discharge treatment such that the coating amounts of Ag and gelatin were 7.8 g/m² and 1.0 g/m².

In the obtained photosensitive film, the silver/binder volume ratio(silver/GEL ratio (vol)) of the emulsion layer was 1/1.

[Exposing and Developing Treatment]

Next, the above photosensitive film was exposed to parallel light from a high-pressure mercury lamp as a light source through a lattice-like photomask capable of providing a developed silver image in which lines and spaces were 5 μm and 195 μm, receptively (a photomask in which photomask lines and spaces were 195 μm and 5 μm (pitch: 200 μm) and the spaces were formed in a lattice form). Subsequently, the resultant was subjected to a treatment including developing, fixing, washing with water, and drying. The developing solution and the fixing solution used are as follows.

(Composition of Developing Solution)

1 L of a developing solution contains the following compounds.

| | | |
|---|---|---|
| Hydroquinone | 15 | g/L |
| Sodium sulfite | 30 | g/L |
| Potassium carbonate | 40 | g/L |
| Ethylenediamine tetraacetic acid | 2 | g/L |
| Potassium bromide | 3 | g/L |
| Polyethylene glycol 2000 | 1 | g/L |
| Potassium hydroxide | 4 | g/L |

pH adjusted to 10.5

(Composition of Fixing Solution)

1 L of a fixing solution contains the following compounds.

| | | |
|---|---|---|
| Ammonium thiosufate (75%) | 300 | ml |
| Ammonium sulfite monohydrate | 25 | g/L |
| 1,3-diaminopropane tetraacetic acid | 8 | g/L |
| Acetic acid | 5 | g/L |
| Ammonia water (27%) | 1 | g/L |
| Potassium iodide | 2 | g/L |

pH adjusted to 6.2

The conductive base film obtained in Preparation Example 1 above was cut into a size of 30 mm×100 mm and was used as a transparent conductive member in Examples 1 to 4 and Comparative Examples 1 to 4.

### Preparation Example 2

### Preparation of Conductive Base Film

Preparation Example 2 was the same as Preparation Example 1 except that compared to Preparation Example 1, in the above description of [Preparation of Transparent Base Film], a COP film support having a thickness of 50 μm whose one surface had been subjected to corona discharge treatment and surface hydrophilization treatment was used. Thus, the detailed description thereof will be omitted. The conductive base film obtained in Preparation Example 2 was cut into a size of 30 mm×100 mm and used as a transparent conductive member in Example 5.

In the examples, a silver salt layer was formed on the PET film support and the COP film support. However, the thickness of the silver salt layer is thin and the thickness of the PET film support and the COP film support is the thickness of the transparent conductive member.

Hereinafter, the methods of preparing Examples 1 to 5 and Comparative Examples 1 to 5 will be described.

In Examples 1 to 4, each multilayer structure was prepared by applying an adhesive to the conductive base film prepared in Preparation Example 1 and attaching a protective member thereto.

In Example 1, the thickness of the adhesive layer was set to 200 μm, the thickness of the PET film support was set to 100 μm, and a PET film having a thickness of 100 μm was used as the protective member.

In Example 2, the thickness of the adhesive layer was set to 25 μm, the thickness of the PET film support was set to 50 μm, and a PET film having a thickness of 25 μm was used as the protective member.

In Example 3, the thickness of the adhesive layer was set to 25 μm, the thickness of the PET film support was set to 100 μm, and a PET film having a thickness of 100 μm was used as the protective member.

In Example 4, the thickness of the adhesive layer was set to 25 μm, the thickness of the PET film support was set to 50 μm, and a PET film having a thickness of 25 μm was used as the protective member.

In Example 5, a multilayer structure was prepared by applying an adhesive to the conductive base film prepared in Preparation Example 2, and attaching a protective member thereto. The thickness of the adhesive layer was set to 25 μm, the thickness of the COP film support was set to 50 μm, and a COP film having a thickness of 25 μm was used as the protective member.

In Comparative Examples 1 to 4, each multilayer structure was prepared by applying an adhesive to the conductive base film prepared in Preparation Example 1 and attaching, a protective member thereto.

In Comparative Example 1, the thickness of the adhesive layer was set to 25 μm the thickness of the PET film support was set to 125 μm, and a PET film having a thickness of 100 μm was used as the protective member.

In Comparative Example 2, the thickness of the adhesive layer was set to 200 μm, the thickness of the PET film support was set to 200 μm, and a PET film having a thickness of 150 μm was used as the protective member.

In Comparative Example 3, the thickness of the adhesive layer was set to 25 μm, the thickness of the PET film support was set to 50 μm, and a PET film having a thickness of 25 μm was used as the protective member.

In Comparative Example 4, the thickness of the adhesive layer was set to 25 μm, the thickness of the PET film support was set to 50 μm, and a PET film having a thickness of 25 μm was used as the protective member.

In Comparative Example 5, the thickness of the adhesive layer was set to 25 μm, the thickness of the PET film support was set to 40 μm, and a PET film having a thickness of 25 μm was used as the protective member.

In the examples, the PET film support and the COP film support were used as the transparent conductive member substrate and the PET film and the COP film were used as the protective member. Regarding the PET film support and the PET film, the thermal shrinkage was adjusted as follows.

A PET film member having a thermal shrinkage of 1.0% was subjected to annealing treatment in an oven at 150° C. and then the thermal shrinkage was adjusted by changing the annealing time.

A PET film member having a thermal shrinkage of 0.5% was subjected to annealing treatment at 150° C. for 5 minutes. A PET film member having a thermal shrinkage of 0.7% was subjected to annealing treatment at 150° C. for 3 minutes. A PET film member having a thermal shrinkage of 0.8% was subjected to annealing treatment at 150° C. for 2 minutes. A PET film member having a thermal shrinkage of 1.0% was not subjected to annealing treatment.

TABLE 1

| | | | | | | Compar- | Compar- | Compar- | Compar- | Compar- |
|---|---|---|---|---|---|---|---|---|---|---|
| | | | | | | ative | ative | ative | ative | ative |
| | Example 1 | Example 2 | Example 3 | Example 4 | Example 5 | Example 1 | Example 2 | Example 3 | Example 4 | Example 5 |
| Transparent | PET | PET | PET | PET | COP | PET | PET | PET | PET | PET |
| conductive | | | | | | | | | | |
| member substrate | | | | | | | | | | |
| Protective member | PET | PET | PET | PET | COP | PET | PET | PET | PET | PET |
| Type of lamination | Both | One | Both | One | One | One | Both | One | One | One |
| structure | surfaces | surface | surfaces | surface | surface | surface | surfaces | surface | surface | surface |
| Thickness of | 600 | 100 | 250 | 100 | 100 | 250 | 750 | 100 | 100 | 90 |
| laminate (μm) | | | | | | | | | | |
| Thickness of | 400 | 25 | 50 | 25 | 25 | 25 | 400 | 25 | 25 | 25 |
| adhesive layer | | | | | | | | | | |
| (μm) | | | | | | | | | | |
| Adhesive | 67% | 25% | 20% | 25% | 25% | 10% | 53% | 25% | 25% | 28% |
| layer/laminate | | | | | | | | | | |
| thickness ratio | | | | | | | | | | |
| Thermal shrinkage | 0.5% | 0.5% | 0.5% | 0.5% | 0.2% | 0.5% | 0.5% | 0.8% | 0.5% | 0.5% |
| of transparent | | | | | | | | | | |
| conductive | | | | | | | | | | |
| member | | | | | | | | | | |
| Thermal shrinkage | 0.8% | 0.8% | 0.8% | 0.7% | 0.2% | 0.8% | 0.8% | 0.8% | 1.0% | 0.8% |
| of protective | | | | | | | | | | |
| member | | | | | | | | | | |
| Thermal shrinkage | 60% | 60% | 60% | 40% | 0% | 60% | 60% | 0% | 100% | 60% |
| difference (thermal | | | | | | | | | | |
| shrinkage ratio of | | | | | | | | | | |
| transparent | | | | | | | | | | |
| conductive | | | | | | | | | | |
| member) | | | | | | | | | | |
| Peeling of member | Not | Not | Not | Not | Not | Occurred | Occurred | Occurred | Occurred | Occurred |
| | occurred | occurred | occurred | occurred | occurred | | | | | |
| Peeling after | Slightly | Slightly | Slightly | Not | Not | — | — | — | — | — |
| acceleration test | occurred at | occurred at | occurred at | occurred | occurred | | | | | |
| | end portion | end portion | end portion | | | | | | | |
| | of member | of member | of member | | | | | | | |
| | (no | (no | (no | | | | | | | |
| | practical | practical | practical | | | | | | | |
| | problem) | problem) | problem) | | | | | | | |

As shown in Table 1 above, in any of Examples 1 to 5, the member was not peeled off. In addition, in Example 4, since the thermal shrinkage difference was in a more preferable range of 40%, the member was not peeled off even in the acceleration test. In Example 5, the thermal shrinkage of the transparent conductive member at 150° C. was 0.2% and was small compared to other examples. Even in the acceleration test, the member was not peeled off. In Examples 1 to 3, a result of no practical problem was obtained in the acceleration test.

On the other hand, in Comparative Example 1 in which the thickness of the adhesive layer is below the range of the present invention, the member was peeled off. In Comparative Example 2 in which the thickness of the laminate exceeds the range of the present invention, the member was peeled off In Comparative Example 3 in which the thermal shrinkage of the transparent conductive member exceeds the range of the present invention, the member was peeled off. In Comparative Example 4 in which the difference between the thermal shrinkage of the transparent conductive member and the thermal shrinkage of the protective member exceeds the range of the present invention, the member was peeled off. In Comparative Example 5 in which the thickness of the laminate is below the range of the present invention, the member was peeled off.

### EXPLANATION OF REFERENCES

10, 10a Multilayer structure
11 Side surface portion
12, 12a Laminate
13 Bent portion
14 Transparent conductive member
15 Molded body
16 Adhesive layer
18 Protective member
20 Transparent substrate
22 First detection electrode
24 Second detection electrode
26 Resin layer
40a First conductive pattern
40b Second conductive pattern
50 Touch panel
52 Touch panel module
54 Detecting portion

What is claimed is:

1. A multilayer structure comprising:
a laminate comprising
a transparent conductive member having a conductive pattern having a mesh structure composed of thin metal wires on a transparent substrate having flexibility,
a protective member for protecting the transparent conductive member, and
an optically transparent adhesive layer disposed between the transparent conductive member and the protective member,
wherein the thickness of the laminate is 100 μm or more and 600 μm or less,
the thickness of the adhesive layer is 20% or more of the thickness of the laminate,
the thermal shrinkage of the transparent conductive member at 150° C. is 0.5% or less, and
a difference between the thermal shrinkage of the transparent conductive member and the thermal shrinkage of the protective member at 150° C. is within 60% of the thermal shrinkage of the transparent conductive member at 150° C.

2. The multilayer structure according to claim 1,
wherein the protective member is disposed on the side of the transparent conductive member which the thin metal wires are provided.

3. The multilayer structure according to claim 2,
wherein the conductive pattern is formed on both surfaces of the transparent substrate.

4. The multilayer structure according to claim 2,
wherein the conductive pattern is formed on one surface of the transparent substrate.

5. The multilayer structure according to claim 4,
wherein the protective member is further provided on the side opposite to the side of the transparent conductive member in which the thin metal wires are provided, and the adhesive layer is disposed between the transparent conductive member and the protective member on the opposite side.

6. The multilayer structure according to claim 1,
wherein the laminate has a three-dimensional shape.

7. The multilayer structure according to claim 2,
wherein the laminate has a three-dimensional shape.

8. The multilayer structure according to claim 3,
wherein the laminate has a three-dimensional shape.

9. The multilayer structure according to claim 4,
wherein the laminate has a three-dimensional shape.

10. The multilayer structure according to claim 5,
wherein the laminate has a three-dimensional shape.

11. A touch panel module comprising:
the multilayer structure according to claim 1.

12. A touch panel module comprising:
the multilayer structure according to claim 2.

13. A touch panel module comprising:
the multilayer structure according to claim 3.

14. A touch panel module comprising:
the multilayer structure according to claim 4.

15. A touch panel module comprising:
the multilayer structure according to claim 5.

16. A touch panel module comprising:
the multilayer structure according to claim 6.

17. A touch panel module comprising:
the multilayer structure according to claim 7.

18. A touch panel module comprising:
the multilayer structure according to claim 8.

19. A touch panel module comprising:
the multilayer structure according to claim 9.

20. A touch panel module comprising:
the multilayer structure according to claim 10.
